(19) United States
(12) Patent Application Publication
(10) Pub. No.: US 2020/0177221 A1
(43) Pub. Date: Jun. 4, 2020

(54) Submerged Maritime Tag Track and Locate Device and System

(71) Applicant: The United States of America as represented by Secretary of the Navy, San Diego, CA (US)

(72) Inventor: Chad M. Gardner, Stuttgart (DE)

(21) Appl. No.: 16/208,848

(22) Filed: Dec. 4, 2018

(51) Int. Cl. H04B 1/38; H01Q 1/04; H01Q 9/04; H01Q 1/34

(52) U.S. Cl. CPC H04B 1/38; H01Q 1/34; H01Q 9/0407; H01Q 1/04

(57) ABSTRACT

A device and system for receiving and transmitting signals underwater. The device comprises a first antenna electrically connected to a transceiver, a second antenna electrically connected to the transceiver, and a battery electrically connected to the transceiver. The first antenna, second antenna, receiver, and battery are supported within a housing member. The transceiver is configured to receive a first signal from the first antenna and transmit a second signal to the second antenna.

### FEDERALLY SPONSORED RESEARCH AND DEVELOPMENT

The Submerged Maritime Tag Track and Locate Device and System is assigned to the United States Government and is available for licensing and commercial purposes. Licensing and technical inquiries may be directed to the Office of Research and Technical Applications, Space and Naval Warfare Systems Center Atlantic (Code 70F00), North Charleston, S.C., 29419 via telephone at (843) 218-3495 or via email at ssc_lant_t2@navy.mil. Reference Navy Case 109262.

### BACKGROUND OF THE INVENTION

### 1. Field of the Invention

This invention relates to a submerged device and system for receiving and transmitting signals, and in particular to a device and system for tracking and locating the position of a maritime vessel relying on through-wall electromagnetic wave theory.

### 2. Description of the Related Art

When a transceiver is placed below the waterline on the hull of a maritime vessel, standard electromagnetic theory holds that the propagation of electromagnetic waves with higher frequencies isn't feasible. In radio communications with satellites, transmissions from satellites to Earth must penetrate the ionosphere. Due to the nature of the ionosphere, there will be a cutoff frequency, below which a radio wave transmitted from a satellite will fail to penetrate a layer of the ionosphere at the incidence angle of the radio transmission. Generally, a satellite will have to transmit at higher frequencies in order to ensure the signal penetrates the ionosphere and reaches the surface of the Earth. However, these higher frequency radio signals are typically unable to propagate underwater.

The Global Positioning System and Iridium Communications satellite carriers are in the L-band, typically between 1 GHz to 2 GHz. Similarly, GLONASS and the Galileo Navigation System utilize the L-band for communications, as do Thuraya satellite phones. While electromagnetic waves at these frequencies have no difficulty penetrating the ionosphere, these 1 GHz to 2 GHz signals are unable to propagate through water.

Guided electromagnetic wave propagation through a dielectric is a well-studied and well-documented phenomenon. In most analyses of antennas used in guided electromagnetic wave propagation through a dielectric, antennas within an air-filled cavities or waveguides achieve the greatest bandwidth.

### SUMMARY OF THE INVENTION

The present invention is a device and system for receiving and transmitting signals underwater. The device comprises a first antenna electrically connected to a transceiver, a second antenna electrically connected to the transceiver, and a battery electrically connected to the transceiver. The first antenna, second antenna, receiver, and battery are supported within a housing member. The transceiver is configured to receive a first signal from the first antenna and transmit a second signal to the second antenna.

According to another embodiment of the invention, the system also comprises a first satellite configured to transmit the first signal to the first antenna, and a second satellite configured to receive the second signal from the second antenna.

### BRIEF DESCRIPTION OF THE DRAWINGS

Throughout the several views, like elements are referenced using like elements. The elements in the figures are not drawn to scale, and some dimensions may be exaggerated for clarity.

FIG. 1 is a front perspective view of an embodiment of the present invention.

FIG. 2 is a front perspective view of an embodiment of the present invention.

FIG. 3 is a diagram of a system according to one embodiment of the present invention.

FIG. 4 is a diagram of a system according to one embodiment of the present invention.

FIG. 5A is a typical return loss plot of the first antenna according to one embodiment of the present invention.

FIG. 5B is a typical return loss plot of the second antenna according to one embodiment of the present invention without the housing member.

FIG. 6A is a typical elevation radiation pattern of the first antenna according to one embodiment of the present invention without the housing member.

FIG. 6B is a typical elevation radiation pattern of the second antenna according to one embodiment of the present invention without the housing member.

FIG. 7A is a typical return loss plot of the first antenna and second antenna according to one embodiment of the present invention.

FIG. 7B is a typical elevation radiation pattern of the first antenna according to one embodiment of the present invention.

FIG. 7C is a typical elevation radiation pattern of the second antenna according one embodiment of the present invention.

FIG. 8A is a plot illustrating the typical percentage of Iridium coverage according to one embodiment of the present invention.

FIG. 8B is a typical return loss plot of the first antenna and second antenna according to one embodiment of the present invention without the dielectric member.

### DETAILED DESCRIPTION OF THE INVENTION

While this invention may be embodied in different forms, the drawings and this section describe in detail specific embodiments of the invention with the understanding that the present disclosure is to be considered merely a preferred embodiment of the invention, and is not intended to limit the invention in any way.

Standard electromagnetic theory holds that higher frequency radio waves in the L-band are unable to propagate through water. Therefore, conventional GPS satellite receivers and Iridium Communications satellite transceivers will not be capable of transmitting or receiving their respective signals when submerged below the surface of the ocean. However, in cases where substantial highly conductive material is not present between the deck of a boat and the hull, electromagnetic waves could be transmitted through the dielectric hull of a boat to a submerged receiver attached to the dielectric hull.

The present invention is a submerged device for receiving and transmitting underwater 100 that locates and tracks the position of a maritime vessel using through-wall electromagnetic wave theory. By relying on the propagation of a satellite signal via through-wall electromagnetic wave theory, the present invention is able to make electromagnetic wave transmission and reception possible underwater, where conventional receivers and transceivers would fail when submerged due to the conductivity of seawater interfering with the transmission of electromagnetic waves. There does not currently exist a system for or method of receiving GPS satellite signals below the ocean surface and retransmitting the received GPS coordinates from a submerged position to a nearby local receiver or low Earth orbiting satellite. The present invention utilizes the large space under a maritime vessel in order to collect and retransmit radio waves by use of an engineer electromagnetic cavity.

According to conventional through-wall electromagnetic theory, when an electromagnetic wave crosses a dielectric member 303, that electromagnetic wave becomes a combination of absorbed, reflected, and pass-through components. It is possible then to design a tailored collector according to the nature of the electromagnetic wave in that particular situation (based on factors such as polarization, phase, and wavelength). While the maritime environment is typically hostile to radio waves (as most radio waves have difficulty passing through water where water acts as a conductor), in a case where there is only a dielectric member 303 and air between the radio wave and a receiver (such as the first antenna 201 or second antenna 202), then the radio wave can be received by the first antenna 201 or second antenna 202 due to the propagation of the radio wave through the dielectric member 303 according to through-wall electromagnetic theory. In such a case, the electromagnetic wave passes only through the dielectric member 303, and isn't reflected as a result of the water's conductivity.

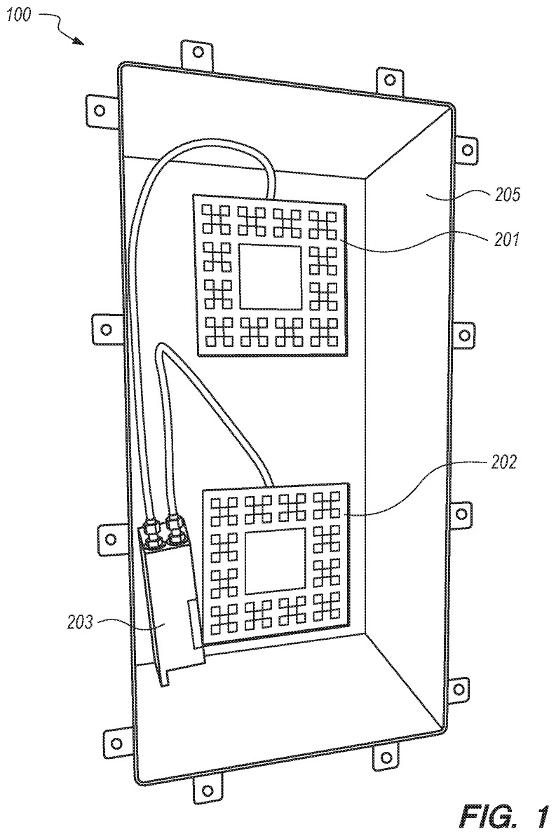

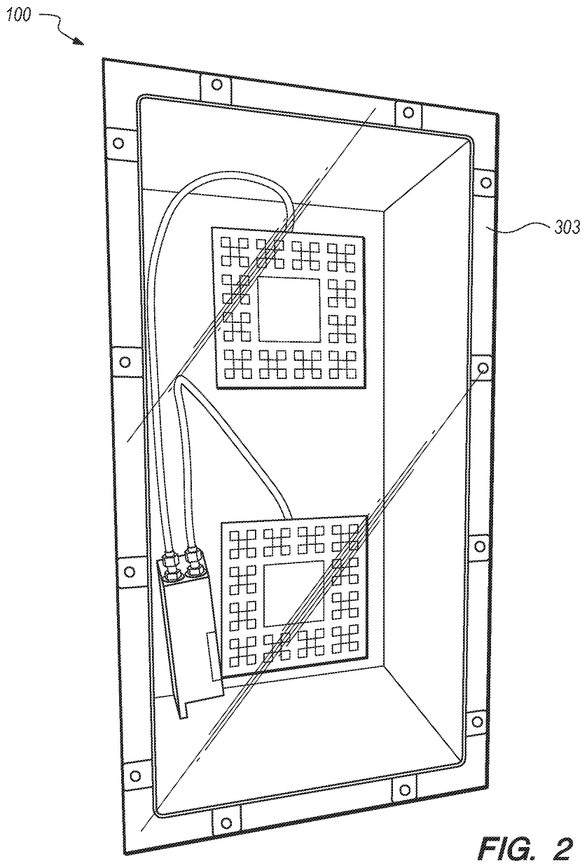

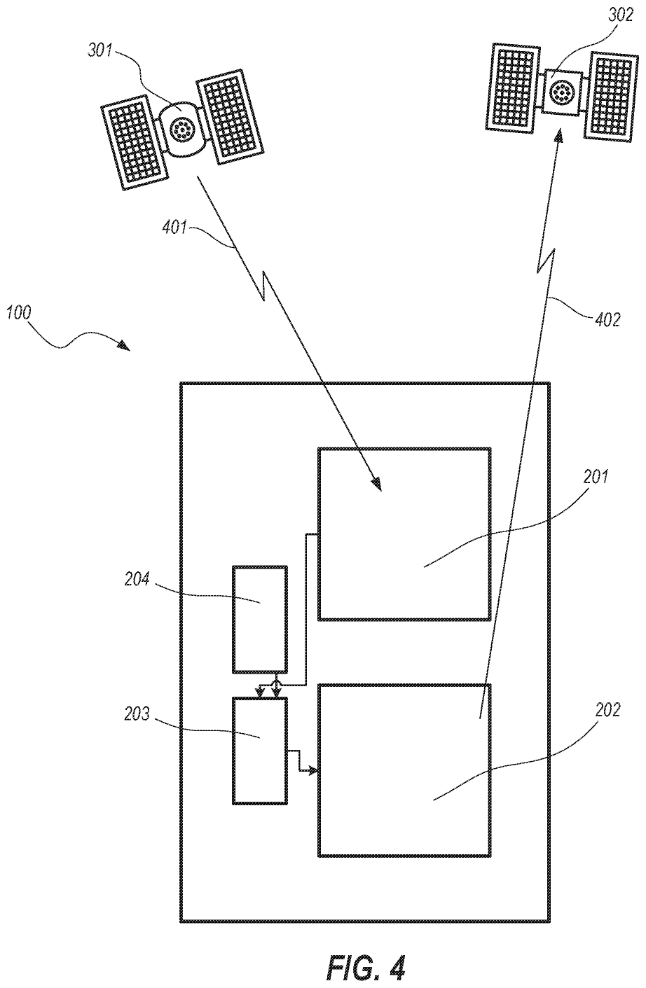

FIG. 1 depicts a device for receiving and transmitting underwater 100 according to one embodiment of the present invention when it is not attached to a dielectric member 303. The device 100 comprises a first antenna 201 electrically connected to a transceiver 203 and a second antenna 202 electrically connected to the transceiver 203. A battery 203 is also electrically connected to the transceiver 203, depicted in FIG. 4. The first antenna 201, the second antenna 202, the transceiver 203, and the battery 204 are housed within a housing member 205. The housing member 205 is attached to a dielectric member 303, depicted in FIG. 2. In one embodiment, the first antenna 201 and second antenna 202 are compact high-performance circularly-polarized microstrip antennas comprising a fractal hi-impedance surface electromagnetic bandgap structure printed on a high permittivity substrate according to Xiu L. Bao et al., A Novel GPS Patch Antenna on a Fractal Hi-Impedance Surface Substrate, IEEE Antennas and Wireless Propagation Letters, Vol. 5, 2006, pp. 232-26. The housing member 205 depicted in FIG. 1 can be an aluminum or plastic, and have a cavity within which the radiating first antenna 201 and second antenna 202 are optimized to receive and transmit 1.5 GHz to 1.7 GHz electromagnetic waves through the dielectric member 303. This frequency range is based on this embodiment of the invention being optimized for GPS signal reception and Iridium Communications satellite transmission and reception. The size and shape of the cavity within the housing member 205 can be optimized according to the frequency range in which the first antenna 201 and second antenna 202 need to operate.

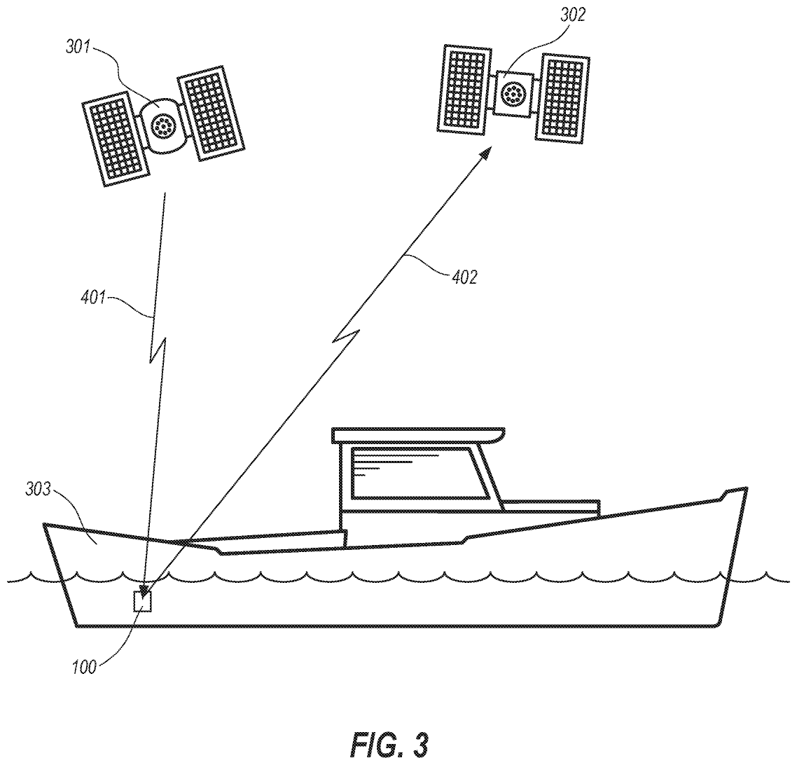

FIG. 3 depicts a system according to an embodiment of the present invention. In this embodiment, the dielectric member 303 is the hull of a maritime vessel. The first satellite 301 is a GPS satellite, which transmits a GPS signal (the first signal 401) through the dielectric member 303 to the device 100. The device 100 then repackages and retransmits its location via Iridium data signal (the second signal 402) to the second satellite 302, which is an Iridium Communications satellite. FIG. 4 shows that the first signal 401 is received at the first antenna 201, while the second signal 402 is transmitted from the second antenna 202. In this embodiment, due to the housing member 205 (and its cavity) being surrounded by water, at L-band operating frequencies, the water behaves as a near perfect electrical conductor. As the first signal 401 and second signal 402 pass through the maritime vessel dielectric member 303, the wave is collected within the cavity of the housing member 205 in a manner analogous to a dish antenna. Both the first antenna 201 and second antenna 202 are connected to the transceiver 203 via standard SMA coaxial cabling. Once the GPS signal first signal 401 is collected by the first antenna 201 and sent to the transceiver 203, the transceiver can route and encode the GPS coordinates for use and transmit them via the second antenna 202 to the second satellite 302 as a second signal 402. The data contained within the second signal 402 can then be used by an end user.

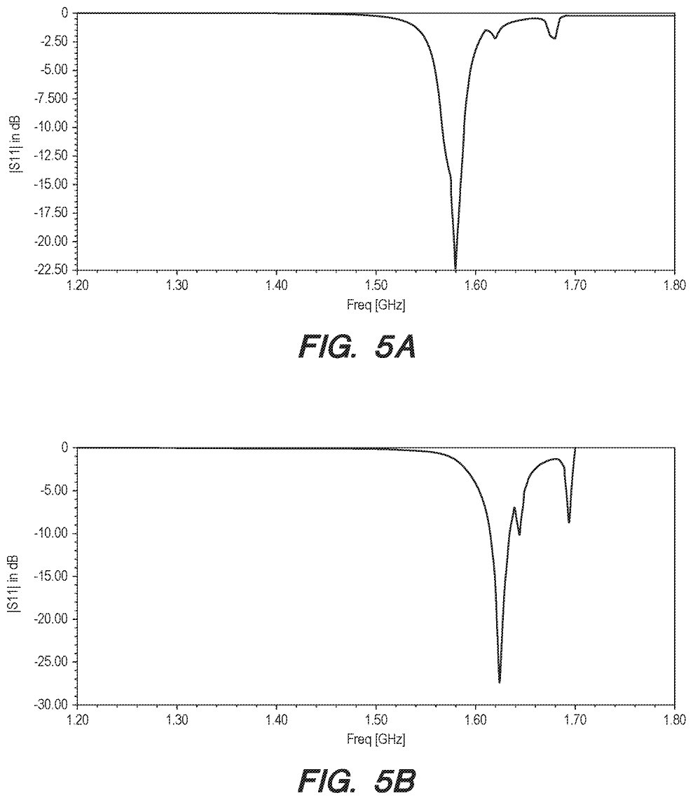

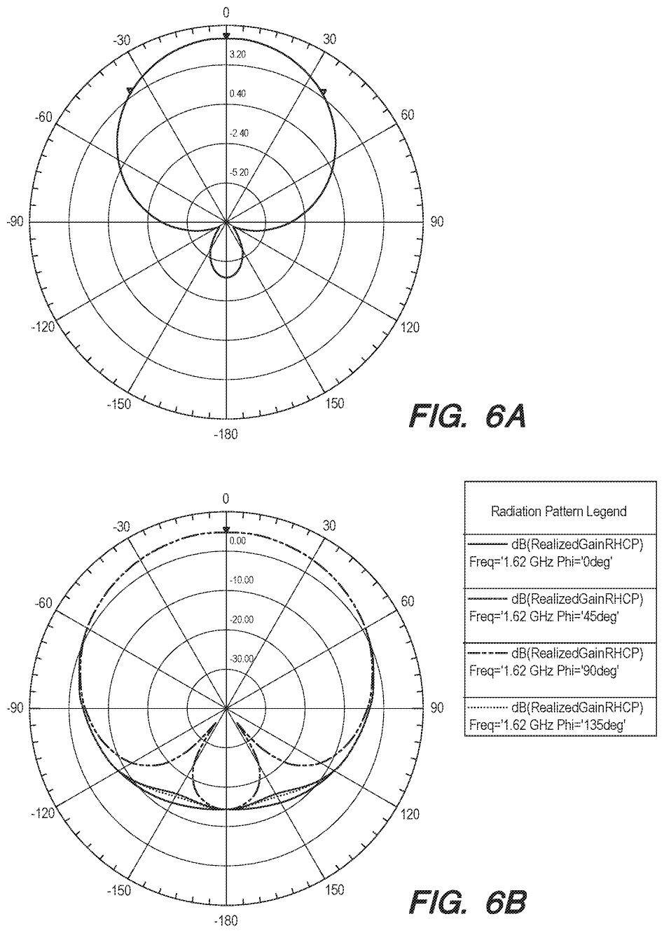

FIG. 5A depicts a return loss plot for the first antenna 201 according to this embodiment of the present invention. FIG. 5A depicts parameters for the first antenna 201 at L-band operating frequencies when the antenna is not placed within a housing member 205. FIG. 5B depicts a return loss plot for the second antenna 202 according to this embodiment of the present invention. FIG. 5B depicts parameters for the second antenna 202 at L-band operating frequencies when the antenna is not placed within a housing member 205. FIG. 6A depicts a simulated radiation pattern for the first antenna 201 when the antenna is not integrated within the housing member 205. FIG. 6B depicts a simulated radiation pattern for the second antenna 202 when the antenna is not integrated within the housing member 205.

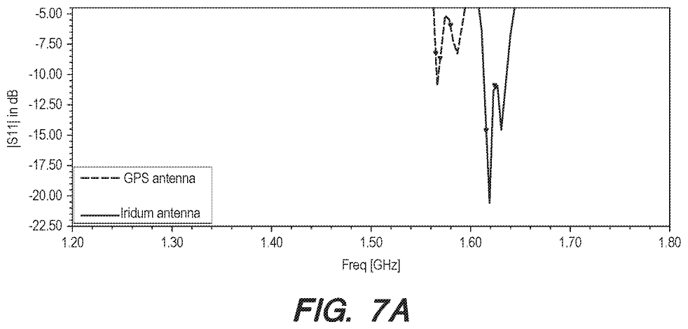

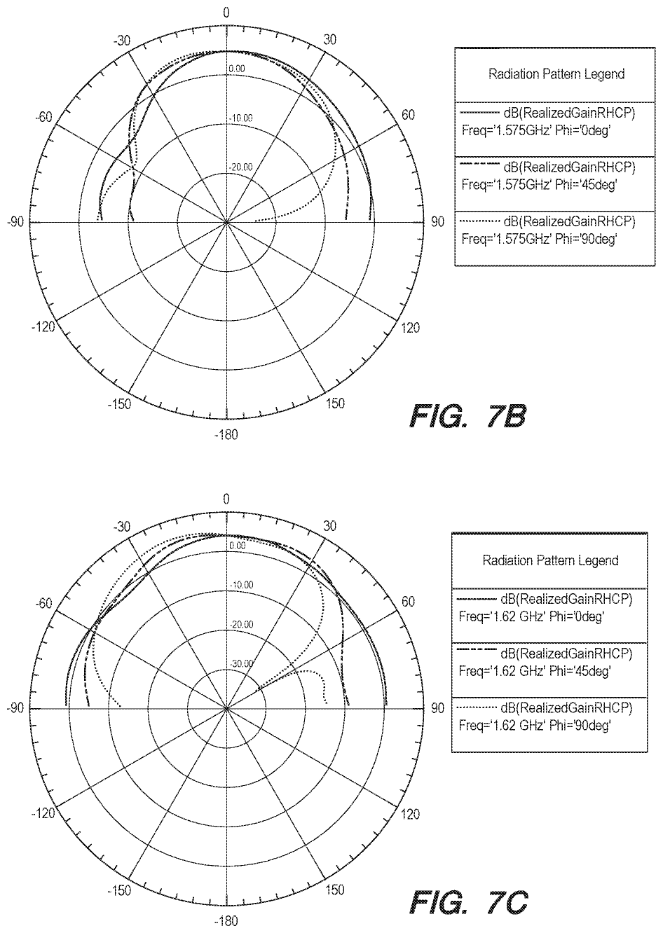

FIG. 7A depicts return loss plots for the first antenna 201 and the second antenna 201 when they are integrated within the housing member 205 according to this embodiment of the present invention. For these results, the housing member 205 is aluminum, and the cavity dimensions were 12 inches in length and six inches in both width and depth. The dielectric member 303 is Rogers TMM® 10 ceramic thermoset polymer composite with a relative permittivity εᵣ of 9.2. FIG. 7B is the simulated GPS radiation pattern of the first antenna 201 when integrated within the housing member 205, and FIG. 7C is the simulated Iridium radiation pattern of the second antenna 202 when integrated within the housing member 205. The first antenna 201 and second antenna 202 utilized first iteration fractal shapes according to Bao. The simulated results assume an infinite groundplane surrounding the dielectric member 303. All simulated radiation patterns are elevation patterns, and decibel levels are with respect to a right-hand-circularly-polarized omnidirectional antenna.

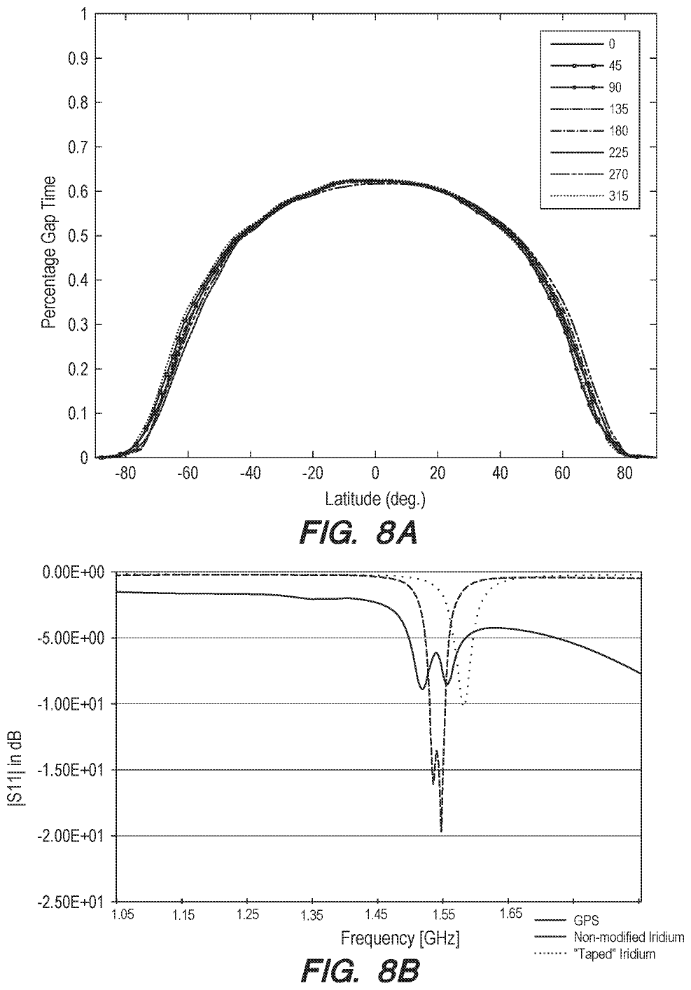

FIG. 8A depicts the coverage of Iridium Communications satellite coverage according to the present invention as a function of latitude. Based on the assumption that the received isotropic power of the Iridium Communications satellites must be −163 dBW in order to close the link, FIG. 8A depicts the percentage of time that there will be no Iridium coverage as a function of latitude.

FIG. 8B depicts the integrated return loss plots of the first antenna 201 and second antenna 202 in a housing member 205 with an air-backed cavity but without the dielectric member 303.

From the above description of the present invention, it is manifest that various techniques may be used for implementing its concepts without departing from the scope of the claims. The described embodiments are to be considered in all respects as illustrative and not restrictive. The method disclosed herein may be practiced in the absence of any element that is not specifically claimed and/or disclosed herein. It should also be understood that the present invention is not limited to the particular embodiments described herein, but is capable of being practiced in many embodiments without departure from the scope of the claims.

1. A device for receiving and transmitting electromagnetic signals underwater, comprising:
a first antenna electrically connected to a transceiver and configured to receive a first electromagnetic signal;
a second antenna electrically connected to the transceiver and configured to transmit a second electromagnetic signal;
a battery electrically connected to the transceiver;
a housing member, wherein the first antenna, the second antenna, the transceiver, and the battery are supported adjacent to the housing member;
a dielectric member adjacent to the housing member, wherein a portion of the dielectric member proximate to the housing member is underwater; and
wherein the first antenna is configured to receive the first electromagnetic signal that propagates into and through the underwater portion of the dielectric member, wherein the second antenna is configured to transmit the second electromagnetic signal that propagates into and through the underwater portion of the dielectric member.

2-4. (canceled)

5. The device of claim 1, wherein the housing member is plastic.

6. The device of claim 1, wherein the first electromagnetic signal is a GPS signal.

7. The device of claim 1, wherein the second electromagnetic signal is an Iridium data signal.

8. A device for receiving and transmitting electromagnetic signals underwater, comprising:
a transceiver;
a first antenna electrically connected to the transceiver and configured to receive a first electromagnetic signal;
a second antenna electrically connected to the transceiver and configured to transmit a second electromagnetic signal;
a battery electrically connected to the transceiver;
a housing member having a recess, which is configured to produce a cavity between the housing member and a dielectric member, wherein the first antenna, the second antenna, the transceiver, and the battery are supported adjacent to the housing member in the recess; and
wherein the transceiver first antenna is configured to receive the first electromagnetic signal from the first antenna that propagates into and through an underwater portion of the dielectric member proximate to the cavity, wherein the second antenna is configured to transmit the second electromagnetic signal that propagates into and through the underwater portion of the dielectric member, wherein the first antenna is a GPS patch antenna, wherein the second antenna is a patch antenna, wherein the housing member is aluminum, wherein the first electromagnetic signal is a GPS signal, wherein the second electromagnetic signal is an Iridium data signal.

9. A system for receiving and transmitting underwater, comprising:
a first satellite for transmitting a first electromagnetic signal;
a second satellite for receiving a second electromagnetic signal;
a device for receiving the first electromagnetic signal and transmitting the second electromagnetic signal underwater, wherein the device comprises
a transceiver;
a first antenna electrically connected to the transceiver and receiving the first electromagnetic signal;
a second antenna electrically connected to the transceiver and transmitting the second electromagnetic signal;
a battery electrically connected to the transceiver;
a housing member having a recess, wherein the first antenna, the second antenna, the transceiver, and the battery are supported within the recess of the housing member;
a dielectric member adjacent to the housing member and together with the housing member forming a cavity encompassing the recess, wherein a portion of the dielectric member proximate to the cavity is underwater;
wherein the first antenna receives the first electromagnetic signal from the first satellite via the underwater portion of the dielectric member; and wherein the second antenna transmits the second electromagnetic signal to the second satellite via the underwater portion of the dielectric member.

10. The system of claim 9, wherein the dielectric member is a maritime vessel hull.

11. The system of claim 9, wherein the first antenna is a patch antenna.

12. The system of claim 9, wherein the second antenna is a patch antenna.

13. The system of claim 9, wherein the housing member is aluminum.

14. The system of claim 9, wherein the housing member is plastic.

15. The system of claim 9, wherein the first satellite is a GPS satellite.

16. The system of claim 9, wherein the second satellite is an Iridium satellite.

17. The system of claim 9, wherein the first electromagnetic signal is a GPS signal.

18. The system of claim 9, wherein the second electromagnetic signal is an Iridium data signal.

19. The system of claim 17, wherein the transceiver is configured to encode GPS data from the first electromagnetic signal into the second electromagnetic signal.

20. The system of claim 19, wherein the dielectric member is ceramic thermoset polymer composite with a relative permittivity of 9.2.

21. The device of claim 1, wherein the dielectric member is a maritime vessel hull and the housing member is configured for mounting on an outside of the maritime vessel hull at the underwater portion of the maritime vessel hull.

22. The device of claim 8, wherein the dielectric member is a maritime vessel hull and the housing member is configured for mounting on an outside of the maritime vessel hull at the underwater portion of the dielectric member.

23. The device of claim 10, wherein the housing member is mounted on an outside of the maritime vessel hull at the underwater portion of the maritime vessel hull.
